(19) United States
(12) Patent Application Publication
(10) Pub. No.: US 2014/0368423 A1
(43) Pub. Date: Dec. 18, 2014

(54) METHOD AND SYSTEM FOR LOW POWER GESTURE RECOGNITION FOR WAKING UP MOBILE DEVICES

(71) Applicant: Nvidia Corporation, Santa Clara, CA (US)

(72) Inventors: Wayne BRENCKLE, San Jose, CA (US); Glenn SCHUSTER, San Jose, CA (US)

(21) Appl. No.: 13/919,784

(22) Filed: Jun. 17, 2013

(51) Int. Cl. G06F 3/01

(52) U.S. Cl. CPC G06F 3/017
USPC 345/156

(57) ABSTRACT

Embodiments of the present invention provide a novel solution which leverages peripheral resources used during the performance of system wake events to detect the presence of gesture input provided by a user during power saving operations (e.g., sleep modes). During the occurrence of a system wake event, embodiments of the present invention utilize proximity detection capabilities of the mobile device to determine if a user is within a detectable distance of the device to provide possible gesture input. When a positive detection comes in, embodiments of the present invention may use the light intensity (e.g., brightness level) measuring capabilities of the mobile device to further determine whether the user is attempting to engage the device to provide gesture input or if the device was unintentionally engaged. Once determinations are made that a user is waiting to engage the gesture recognition capabilities of the mobile device, embodiments of the present invention rapidly activate the gesture recognition engine (e.g., gesture sensor) and may coincidentally notify the user (e.g., using LED notification) that the device is ready to accept gesture input from the user.

### FIELD OF THE INVENTION

Embodiments of the present invention are generally related to mobile devices capable recognizing gesture movements performed by a user as input commands.

### BACKGROUND OF THE INVENTION

Gesture recognition technology enables users to engage their devices through the performance of recognizable movements or “gestures” without the assistance of mechanical devices or physical contact. Gestures can include hand and/or finger movements for instance. Gestures performed by users may serve as discrete input commands which correspond to actions to be performed by the device. Furthermore, conventional devices incorporating such gesture recognition technology may include mobile devices, such as laptops and mobile phones, which generally operate on limited battery power.

During power saving operations in which these conventional devices operate in a low powered state (e.g., sleep mode), components used in gesture recognition (e.g., gesture sensors) also may enter this low powered state which limits the ability of these devices to detect potential gestures that may be accepted as input. In this manner, the user may be forced to physically engage the device in order to return it back to a higher powered state so that it may resume standard gesture recognition operations (e.g., “waking up” the device).

However, allowing components used in gesture recognition to remain powered during power saving operations may consume power unnecessarily at the expense of standby power. As such, this issue may be especially problematic for mobile devices, given the limited power resources available, and may lead to increased user frustration at having to physically handle a device every time the user wishes to engage its gesture recognition features during power saving operations.

### SUMMARY OF THE INVENTION

Accordingly, a need exists to address the problems discussed above. What is needed is a method and/or system that enables the user to engage gesture recognition features of a mobile device without physically handling the device during power saving operations. Embodiments of the present invention provide a novel solution which leverages peripheral resources used during the performance of system wake events to detect the presence of gesture input provided by a user during power saving operations (e.g., sleep modes). During the occurrence of a system wake event, embodiments of the present invention utilize proximity detection capabilities of the mobile device to determine if a user is within a detectable distance of the device to provide possible gesture input. When a positive detection comes in, embodiments of the present invention may use the light intensity (e.g., brightness level) measuring capabilities of the mobile device to further determine whether the user is attempting to engage the device to provide gesture input or if the device was unintentionally engaged. Once determinations are made that a user is waiting to engage the gesture recognition capabilities of the mobile device, embodiments of the present invention rapidly activate the gesture recognition engine (e.g., gesture sensor) and may coincidentally notify the user (e.g., using LED notification) that the device is ready to accept gesture input from the user.

More specifically, in one embodiment, the present invention is implemented as a method of gesture recognition. The method includes detecting a system wake event performed using a first portion of a computer system within a mobile device while a second portion of the computer system is within a low power state. In one embodiment, the system wake event is a signal paging operation periodically performed by the mobile device. The method also includes powering up a second portion of the computer system in response to the system wake event for detecting potential performance of a gesture input command initiated by a user. In one embodiment, the second portion of the computer system comprises at least a proximity sensor, a light sensor and a gesture sensor. In one embodiment, the method of powering up further includes removing the second portion of the computer system from operating in a sleep or reduced power mode. In one embodiment, the detecting performance further includes detecting proximity of a hand relative to the computer system. In one embodiment, the detecting performance further includes gathering brightness level data relative to said computer system. In one embodiment, the detecting performance further includes prompting the user for the gesture input command using visual notification. The method also includes executing a gesture-activated process in response to the gesture input command.

In one embodiment, the present invention is implemented as an electronic system for gesture recognition. The system includes a controller operable to detect a system wake event performed within a computer system of a mobile device, in which the controller is operable to power up the gesture recognition module and the gesture sensor in response to the system wake event. In one embodiment, the system wake event is a signal paging operation periodically performed by the mobile device. In one embodiment, the controller is further operable to remove the gesture sensor from operating in a sleep or low power mode. In one embodiment, the controller is further operable to power up a proximity sensor in response to the system wake event to detect proximity of a hand relative to the computer system for the gesture recognition module. In one embodiment, the controller is further operable to power up a light sensor in response to the system wake event to gather brightness level data relative to the computer system for the gesture recognition module.

The system also includes a gesture recognition module operable to detect performance of a gesture input command, in which the gesture recognition module is operable to execute a gesture-activated process in response to the gesture input command. In one embodiment, the gesture recognition module is further operable to prompt the user for the gesture input command using visual notification. In one embodiment, the gesture recognition module is further operable to assign a process to the gesture input command. The system also includes a gesture sensor operable to capture the gesture input command provided by a user.

In one embodiment, the present invention is implemented as a method of gesture recognition. The method includes detecting a system wake event performed using a first portion of a computer system within a mobile device. In one embodiment, the system wake event is a signal paging operation periodically performed by the mobile device. The method also includes powering up a gesture sensor in response to the system wake event for detecting performance of a gesture input command provided by a user. In one embodiment, the method of powering up includes removing the gesture sensor from operating in a reduced mode. In one embodiment, the method of powering up further includes powering up a proximity sensor to detect proximity of a hand relative to the computer system. In one embodiment, the method of powering further includes powering up a light sensor to gather brightness level data relative to the computer system. In one embodiment, the method of detecting performance further includes prompting the user for the gesture input command using visual notification. The method also includes executing a computer-activated process in responsive to the gesture input command. In one embodiment, the method of executing further includes assigning the gesture-activated process to the gesture input command.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A is a block diagram depicting components used in an exemplary system operations during a sleep state in accordance with embodiments of the present invention.

FIG. 1B is a graphical illustration of an exemplary data gathering process used in a low power gesture recognition wake-up process in accordance with embodiments of the present invention.

FIG. 2 is a block diagram depicting components used in an exemplary data gathering process used in a low power gesture recognition wake-up process in accordance with embodiments of the present invention.

FIG. 3 is a block diagram depicting components used in an exemplary gesture input capture process used in low power gesture recognition wake-up process in accordance with embodiments of the present invention.

FIG. 4A is an illustration that depicts an exemplary data gathering process used in a low power gesture recognition wake-up process in accordance with embodiments of the present invention.

FIG. 4B is an illustration that depicts an exemplary gesture input capture process used in an exemplary low power gesture recognition wake-up process in accordance with embodiments of the present invention.

FIG. 5A is a flowchart that depicts an exemplary computer-implemented low power gesture recognition wake-up process in accordance with embodiments of the present invention.

FIG. 5B is another flowchart that depicts a computer-implemented low power gesture recognition wake-up process in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

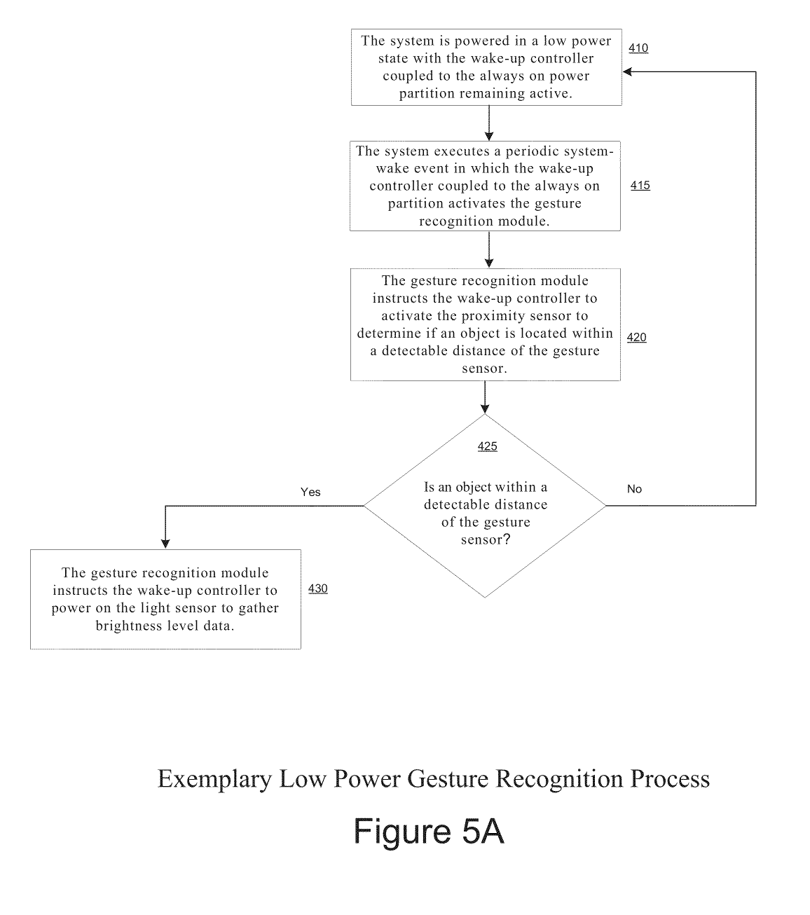

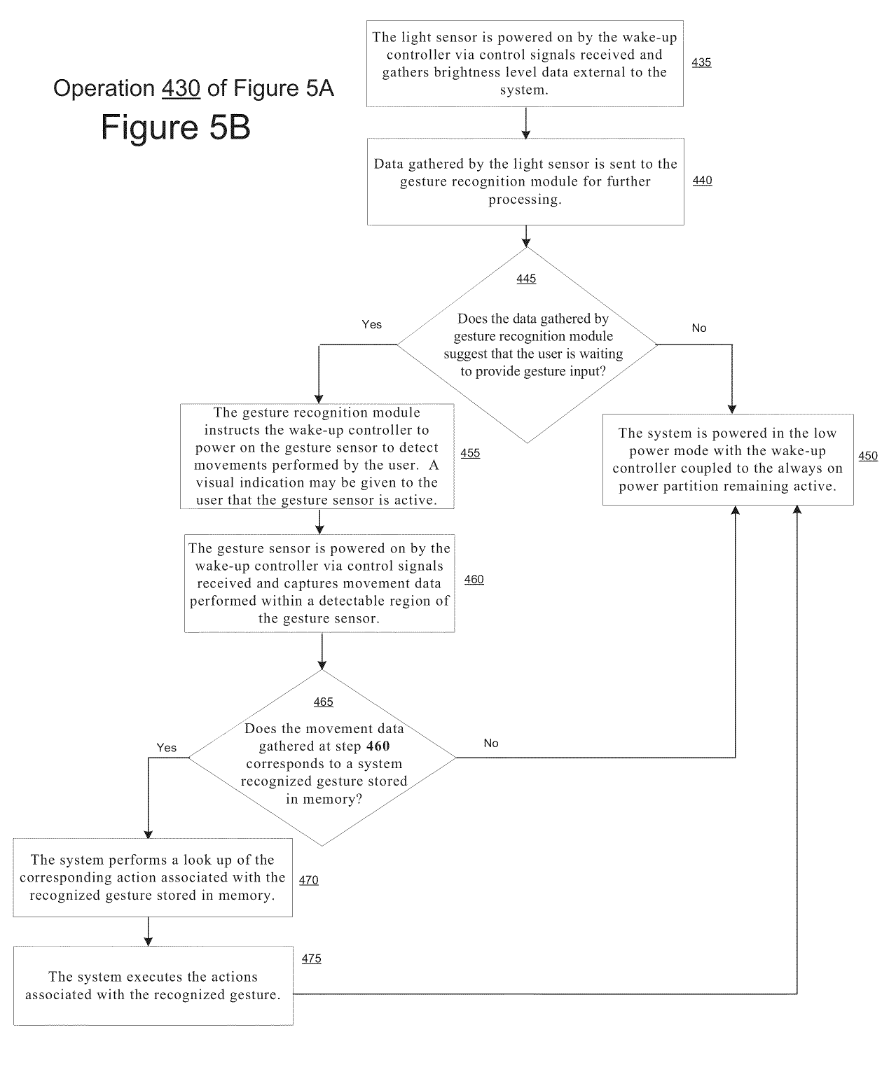

Portions of the detailed description that follow are presented and discussed in terms of a process. Although operations and sequencing thereof are disclosed in a figure herein (e.g., FIGS. 5A and 5B) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, an object, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

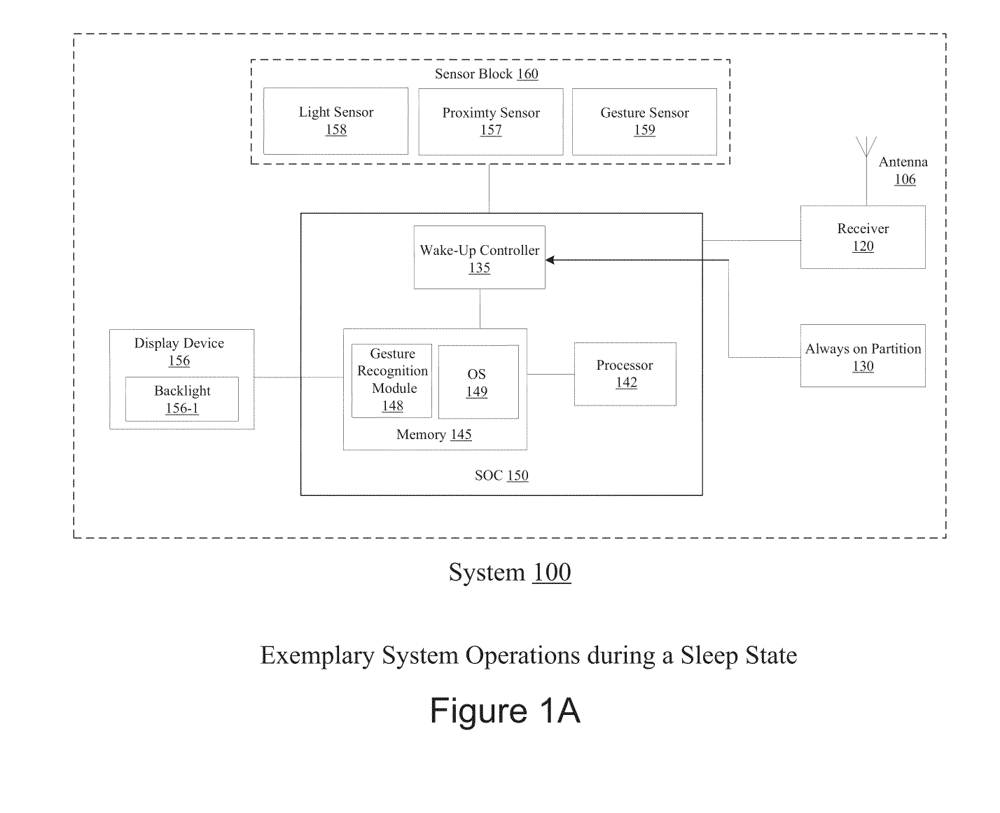

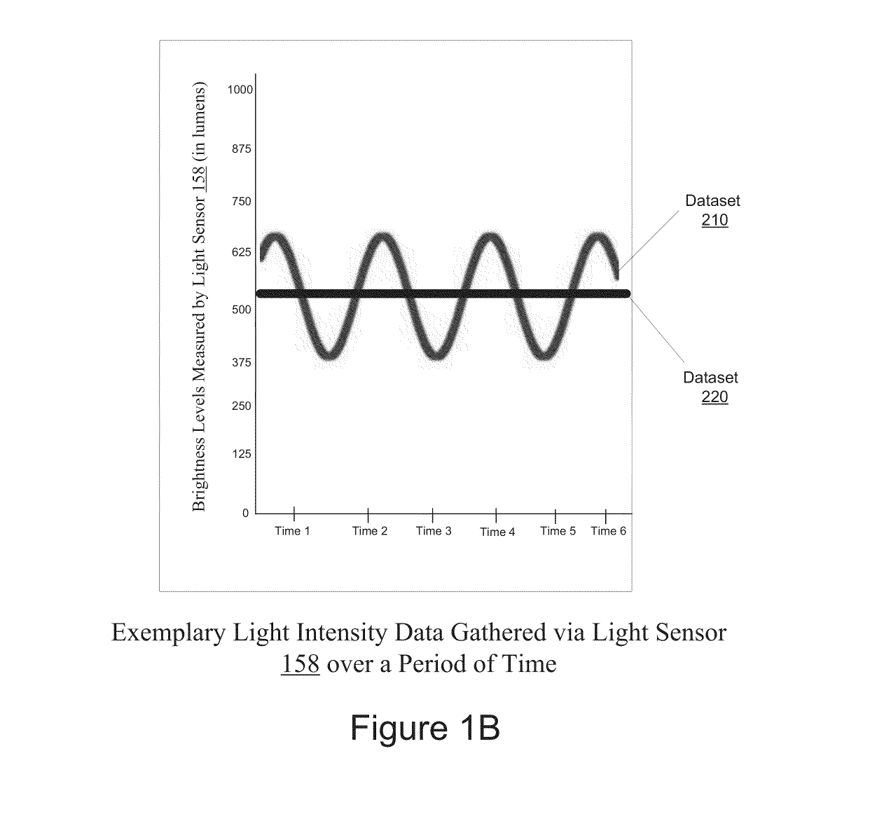

As presented in FIG. 1, an exemplary system 100 upon which embodiments of the present invention may be implemented is depicted. System 100 can be implemented as, for example, a digital camera, cell phone camera, portable electronic device (e.g., audio device, entertainment device, handheld device), webcam, video device (e.g., camcorder) and the like. Furthermore, components of system 100 may be coupled via internal communications bus and may receive/transmit data for further processing over such communications bus.

FIG. 1 depicts an embodiment of the present invention in which components within system 100 operate in a low or reduced powered mode or “sleep” state, with exception to wake-up controller 135. Wake-up controller 135 may be coupled to always on partition 130, which may be a power partition capable of providing components coupled to it with a sufficient amount of power such that they are able to actively perform their respective functions. Wake-up controller 135 may be capable of sending/receiving control signals to and from other components within system 100. As such, wake-up controller 135 may be operable to remove components of system 100 from the sleep state and resume performance of their respective functions using control signals sent by wake-up controller 135. According to one embodiment, wake-up controller 135 may communicate with components using control signals sent through I²C bus using an I²C controller interface.

Furthermore, according to one embodiment, control signals sent by wake-up controller 135 may be used during the performance of periodic system wake events, which are designed to restore components within system 100 from a sleep state to a higher powered mode based on scheduled system events. Scheduled system events may be timed processes that operate in the background at certain periods and generally do not require user interaction (e.g., signal paging operations, processes executed by operating system 149, system maintenance procedures, etc.). As such, embodiments of the present invention may synchronize the periodic transmission of “pulse” control signals sent to sensor block 160 via wake-up controller 135 with the occurrence of system wake events in system 100.

According to one embodiment, gesture recognition module 148, residing in memory 145, may be a module capable of using data gathered by components of sensor block 160 to determine if a user has provided recognizable discrete movements (e.g., “gestures”) as input for further processing by system 100. Gesture recognition module 148 may be activated (or initialized) in response to the occurrence of an initiation event detected during a system wake event. Upon activation, gesture recognition module 148 may instruct wake-up controller 135 to activate various components within sensor block 160 for data gathering purposes. As such, components within system 100 may be able to perform operations in response to the data gathered by components of sensor block 160.

With further reference to the embodiment depicted in FIG. 1, sensor block 160 may comprise light sensor 158, proximity sensor 157 and gesture sensor 159 (e.g., a camera) along with any of their respective sub-components. In one embodiment, sensor block 160 may be capable of receiving I²C signals from wake-up controller 135. In one embodiment, light sensor 158, proximity sensor 157 and/or gesture sensor 159 may be positioned in a manner that enables system 100 to capture gesture input provided by a user. According to one embodiment, gesture sensor 159 may operate in combination with light sensor 158 and/or proximity sensor 157 to detect gestures performed by a user. According to one embodiment, the functional aspects of gesture sensor 159, light sensor 158 and proximity sensor 157 may be combined within one sensor (e.g., sensor block 160 may be a single sensor).

Proximity sensor 157 may be a device capable of gathering proximity data regarding the distance of an object with respect to system 100 without physical contact. According to one embodiment, data gathered by proximity sensor 157 may be used by gesture recognition module 148 in determining whether an object (e.g., hand or digits of a hand) is within proximity of gesture sensor 159 and requires further monitoring by gesture recognition module 148. In one embodiment, proximity sensor 157 may be operable to emit electromagnetic beams (e.g., infrared beams) within a sensing range and detect changes in amplitude within return signals reflected back to the sensor (e.g., object reflectance). In this manner, proximity sensor 157 may determine the proximity of a hand based on beams emitted from proximity sensor 157 that are reflected off of the hand and back into proximity sensor 157. In one embodiment, proximity sensor 157 may use multiple LEDs to provide greater accuracy and a wider object detectability range.

As such, according to one embodiment, data gathered by proximity sensor 157 may be used by gesture recognition module 148 to determine whether or not a user is attempting to engage gesture sensor 159 to provide gesture input. For instance, according to one embodiment, if a hand is not within a detectable distance of proximity sensor 157, components within system 100 may continue to maintain a current sleep state and conserve power resources (e.g., light sensor 158 and/or gesture sensor 159 may not require activation for gesture input processing and, thus, may maintain a current sleep state). Conversely, if a hand is within a detectable distance of proximity sensor 157, gesture recognition module 148 may activate light sensor 158 via control signals sent by wake-up controller 135 for further processing based on the data gathered. Although embodiments of the present invention described herein focus on hand movements performed, embodiments of the present invention are not limited to such, and may extend to other detectable objects (e.g., objects besides parts of the body).

Light sensor 158 may be a device capable of gathering light intensity data (e.g., brightness level data) over a period of time from a variety of different ambient light sources (e.g., sunlight, florescent light sources, incandescent lamps). As such, embodiments of the present invention may use procedures to correlate light intensity data gathered by light sensor 158 with a user attempting to engage gesture sensor 159 to provide gesture input. Data used for such procedures may be a priori data loaded within memory 145 and accessible to components within system 100 (e.g., gesture recognition module 148) for further processing.

For instance, according to one embodiment, data gathered by light sensor 158 may be used by gesture recognition module 148 in determining whether or not a hand is currently within a detectable distance of gesture sensor 159. As such, light sensor 158 may detect light intensity levels determined by gesture recognition module 148 as being consistent with system 100 being placed in an open-space area with sufficient lighting. Accordingly, gesture recognition module 148 may activate proximity sensor 157 via control signals sent by wake-up controller 135 to determine proximity of a hand relative to gesture sensor 159 based on the data gathered. Conversely, light sensor 158 may detect light intensity levels determined by gesture recognition module 148 as being consistent with system 100 being stowed (e.g., system 100 placed within a garment pocket or case). As such, components within system 100 may continue to maintain a current sleep state and conserve power resources (e.g., proximity sensor 157 and/or gesture sensor 159 may not require activation for gesture input processing and, thus, may maintain a current sleep state).

Furthermore, embodiments of the present invention may gather light intensity data over a period of time (e.g., milliseconds) to determine whether a user is attempting to engage gesture sensor 159 to provide gesture input. For instance, during a system wake event, a user may perform hand movements (unrelated to the specific gesture input to be provided by the user) in an attempt engage to gesture sensor 159. As such, light sensor 158 may detect periods of decreased light intensity external to system 100 at points in which the user's hand obstructs light sensor 158 from receiving light during performance of the unrelated hand movement. Alternatively, light sensor 158 may perceive periods of increased light intensity external to system 100 at points in which the user's hand does not obstruct light sensor 158 from receiving light during performance the same unrelated hand movement. As such, gesture recognition module 148 may use this data gathered by light sensor 158 over a period of time to determine whether gesture sensor 159 needs to be activated to receive gesture input.

FIG. 1B is a graphical illustration of how data gathered over a period of time (e.g., milliseconds) by light sensor 158 may be used to determine the activation status of gesture sensor 159 during a system wake event in accordance with embodiments of the present invention. FIG. 1B depicts two datasets captured by light sensor 158: one dataset in which the user is attempting to engage gesture sensor 159 (e.g., dataset 210) and one dataset in which the user is not attempting to engage gesture sensor 159 (e.g., dataset 220). The linear nature of the light intensity values associated with dataset 220 may be determined by gesture recognition module 148 as consistent with the user not engaging gesture sensor 159. For example, the consistency of these values may be indicative of system 100 being placed within a garment pocket or placed on a counter top for a period of time (e.g., system 100 receiving the same brightness levels over a period of time). Under such conditions, according to one embodiment, gesture recognition module 148 may not require any additional data from the sensors of sensor block 160 and may allow gesture sensor 159 to remain in a sleep state.

However, the non-linear nature of the light intensity values associated with dataset 210 may be determined by gesture recognition module 148 as consistent with the user attempting to engage gesture sensor 159 to provide gesture input. For example, the oscillation of light intensity values associated with dataset 210 may be indicative the user performing hand movements in an attempt to engage gesture sensor 159. For instance, as the user's hand approaches gesture sensor 159, light intensity values (e.g., brightness levels) detected by light sensor 158 may begin to decrease. Conversely, as the user's hand moves away from gesture sensor 159, light intensity levels detected by light sensor 158 may begin to increase. Accordingly, gesture recognition module 148 may recognize these changes in light intensity values and determine that the user may be attempting to engage gesture sensor 159.

According to one embodiment, based on the data received from proximity sensor 157 and/or light sensor 158, gesture recognition module 148 may proceed to activate gesture sensor 159 for further processing via control signals sent by wake-up controller 135. Gesture sensor 159 may be a device capable of detecting gestures performed by a user within a given space (e.g., 2D, 3D, etc.). According to one embodiment, gesture sensor 159 may be an array of sensors capable of capturing movements performed by a user through infrared signals. According to one embodiment, gesture sensor 159 may be a digital camera device (e.g., low-resolution camera device) or multiple camera devices (e.g., stereoscopic camera devices).

As such, gestures captured by gesture sensor 159 may be used as input for further processing by components of system 100. For instance, according to one embodiment, gesture sensor 159 may be able to detect hand gestures performed by the user which correspond to directional commands to be performed on system 100 (e.g., the user moves a cursor on display device 156 by moving the user's hand in either an up, right, down, or left motion from a position relative to gesture sensor 159). In one embodiment, gesture recognition module 148 may notify the user that gesture sensor 159 has been activated and is ready to receive gesture input through visual or audio notification techniques (e.g., LED, alert tones, etc.). According to one embodiment, gesture sensor 159 may be able to detect facial gestures performed by the user.

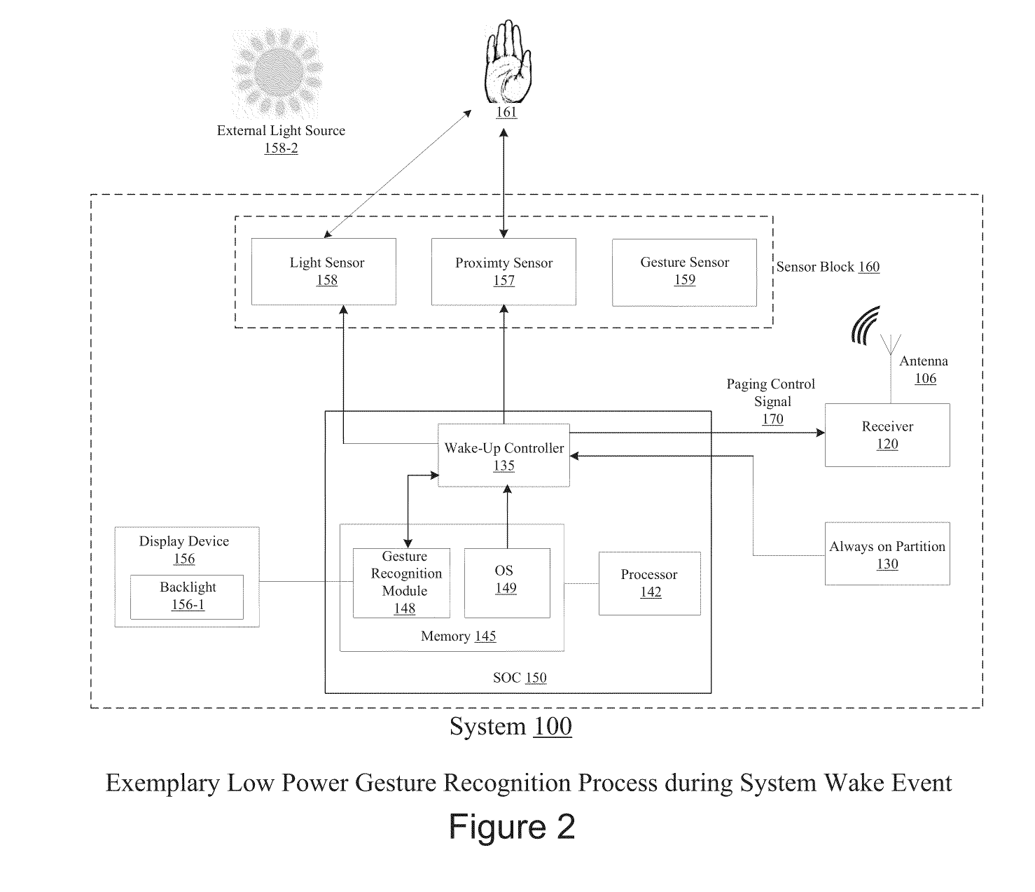

FIG. 2 depicts an embodiment in which objects capable of providing gesture input (e.g. user's hand 161) are monitored concurrent to the performance of a system wake event (e.g., signal paging operations) in accordance with embodiments of the present invention. As part of the scheduled performance of signal paging, wake-up controller 135 may send paging control signals 170 to receiver 120. As such, receiver 120 may be activated and begin the performance of the requested signal paging operations using antenna 106. Paging wake-up events may operate periodically (e.g., at a rate of approximately 2 Hz). Concurrently, wake-up controller 135 may also activate gesture recognition module 148, which may in turn instruct wake-up controller 135 to activate sensors within sensor block 160 to determine whether a user is attempting to provide gesture input commands (communication depicted as bi-directional arrows between wake-up controller 135 and gesture sensor module 148). Upon the receipt of instructions from gesture recognition module 148, wake-up controller 135 may send control signals to engage sensor block 160 to gather data.

According to one embodiment, proximity sensor 157 may be activated (or initialized) to gather proximity data during the performance of the signal paging operations. The proximity detection capabilities of proximity sensor 157 may enable proximity sensor 157 to send out pulse signals (e.g., signals sent at a rate greater than or equal to 2 Hz) to look for objects within a detectable distance of gesture sensor 159 (e.g., 10 cm above system 100). In one embodiment, beams emitted by proximity sensor 157 may be of such frequency that proximity sensor 157 may be able to distinguish data gathered from those beams and the light provided by external light source 158-2.

As depicted in FIG. 2, gesture recognition module 148 may determine that hand 161 is within proximity of gesture sensor 159 (e.g., based on data gathered by proximity sensor 157) and, therefore, may instruct wake-up controller 135 to further activate light sensor 158 via control signals for further processing. As illustrated in FIG. 2, light sensor 158 may detect light intensity levels consistent with the user attempting to engage gesture sensor 159. As such, the data gathered by proximity sensor 157 and/or light sensor 158 with respect to the detected presence of hand 161 may alert gesture recognition module 148 that the user may be attempting to engage gesture sensor 159.

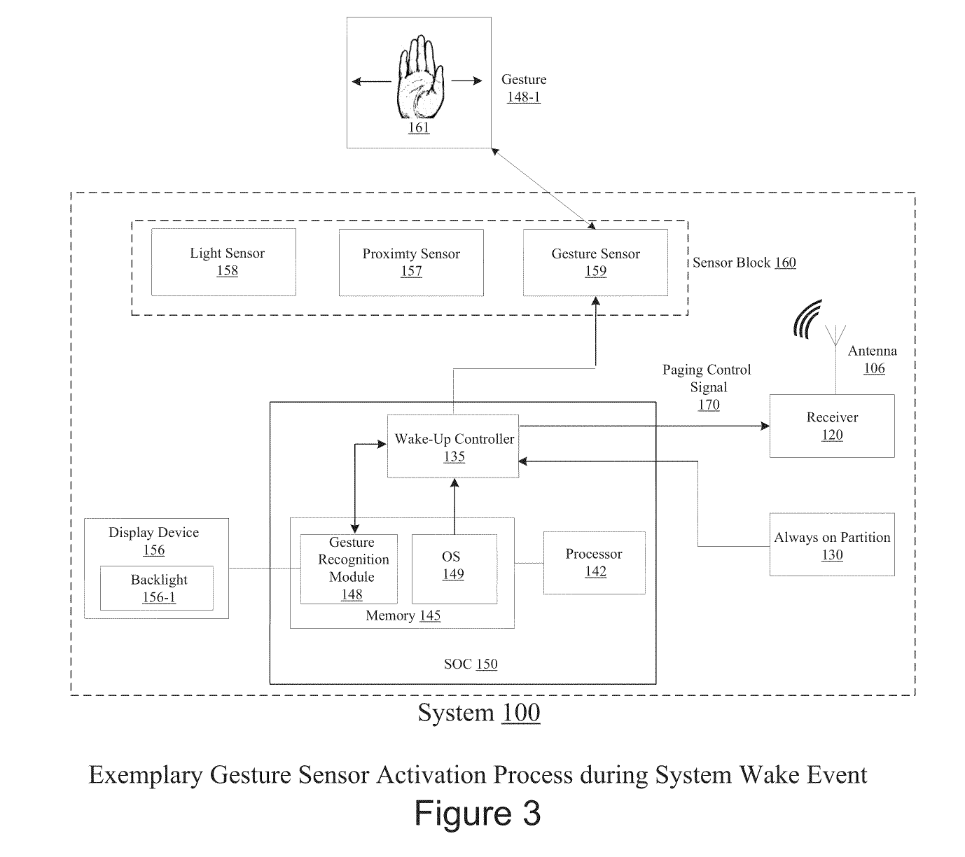

FIG. 3 depicts an embodiment in which gesture sensor 159 is removed from a sleep state during a system wake event and powered on based on determinations made by gesture recognition module 148 in accordance with embodiments of the present invention. As illustrated in FIG. 3, gesture recognition module 148 may proceed to activate gesture sensor 159 for further processing via control signals sent by wake-up controller 135 in response to a determination made by gesture recognition module 148 that the user is attempting to engage gesture sensor 159. In one embodiment, gesture sensor 159 may capture the performance of gesture 148-1 through infrared signals emitted by gesture sensor 159. In one embodiment, image data associated with gesture 148-1 may be captured using a single camera device (e.g., low-resolution camera) or through a multiple camera scheme (e.g., stereoscopic cameras). As such, gesture 148-1 captured by gesture sensor 159 may be used as input for further processing by components of system 100.

According to one embodiment, gesture recognition module 148 may execute an assigned or recognized task using components within system 100 upon the recognition of gesture 148-1 as a valid input command. Valid gesture input commands along with their corresponding tasks may be stored in a data structure or memory resident on system 100. Furthermore, in one embodiment, gesture recognition module 148 may be operable to assign different tasks to different gesture inputs. For instance, gesture 148-1 may be assigned to a system “unlock” operation. According to one embodiment, gesture inputs and their respective assigned tasks may be configured using a GUI or imported into the data structure or memory resident system 100 using a system import tool.

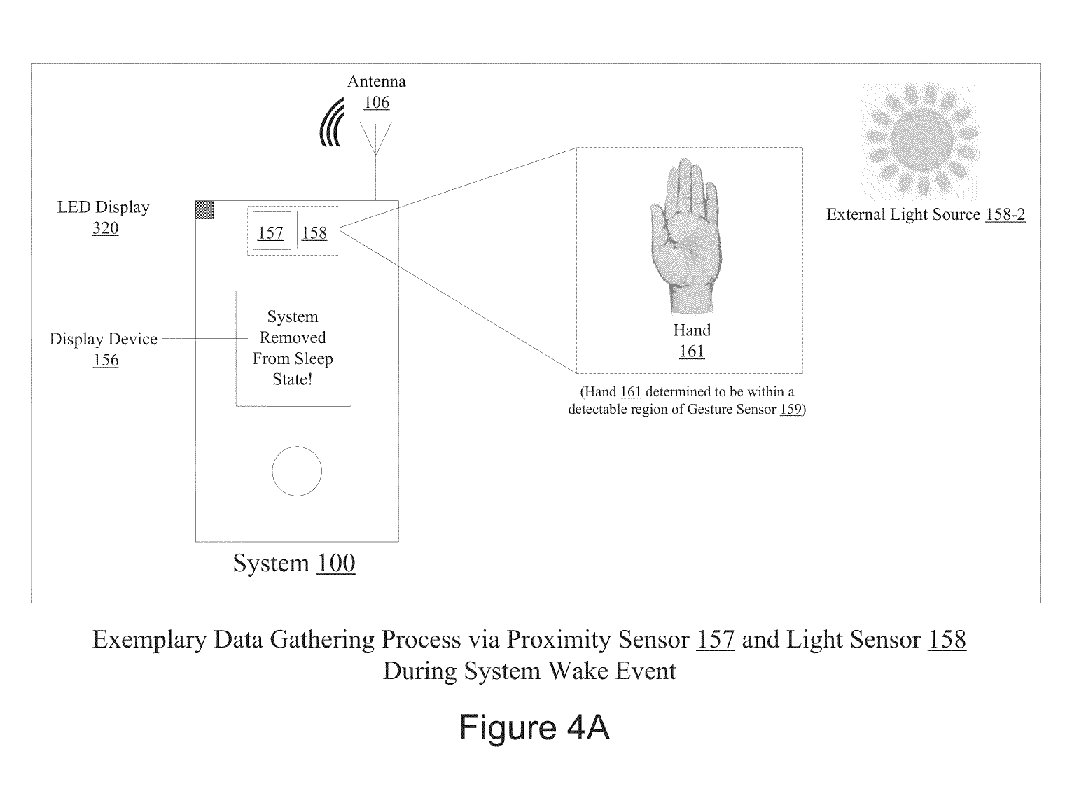

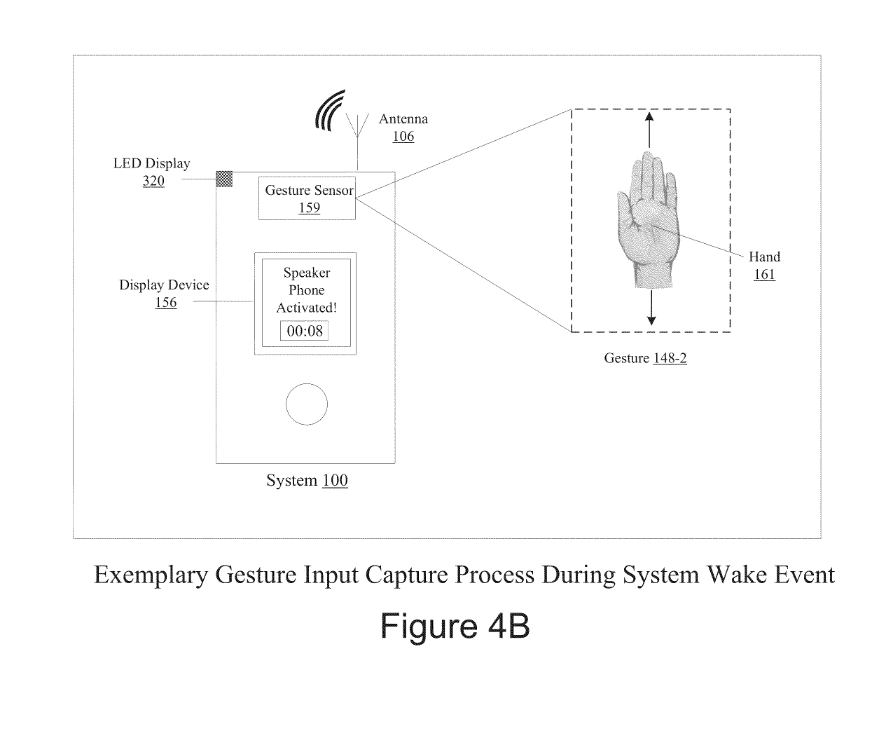

FIG. 4A illustrates how data gathered by gesture recognition module 148 during the performance of a system wake event may lead to the subsequent activation of gesture sensor 159 in accordance with embodiments of the present invention. As depicted in FIG. 4A, the system wake event may be a scheduled system wake event, such as signal paging operations. During the performance of the signal paging operations, wake-up controller 135 may send pulse signals which engage sensor block 160 (e.g., proximity sensor 157 and/or light sensor 158) to gather data for gesture recognition module 148. Accordingly, proximity sensor 157 may send out signal pulses capable of detecting objects in proximity to gesture sensor 159 (e.g., 10 cm above system 100).

Given that hand 161 is within a detectable distance of gesture sensor 159, gesture recognition module 148 may instruct wake-up controller 135 to activate light sensor 158 via control signals for further processing. Based on the data gathered by proximity sensor 157 and/or light sensor 158, gesture recognition module 148 may determine that that a user is attempting to engage gesture sensor 159 and, therefore, may instruct wake-up controller 135 to wake-up gesture sensor 159 and capture any incoming gesture input provided by the user (see FIG. 4B). Furthermore, as depicted by FIG. 4A, in one embodiment, gesture recognition module 148 may notify the user that gesture sensor 159 is activated and ready to accept gesture input based on the visual notification provided by LED display 320.

With reference to FIG. 4B, once gesture recognition module 148 determines that that the user is attempting to engage gesture sensor 159, gesture recognition module 148 may instruct wake-up controller 135 to activate gesture sensor 159 to capture any incoming gesture input provided. As depicted by FIG. 4B, in one embodiment, the user may recognize that gesture sensor 159 is activated and ready to accept gesture input based on the visual notification provided by LED display 320. Furthermore, upon recognition of gesture 148-2 as valid gesture input by gesture recognition module 148, system 100 may proceed to execute operations associated with the task assigned to gesture 148-2 (e.g., placing system 100 in a speakerphone mode to answer an incoming phone call).

FIG. 5A presents an exemplary computer-controlled low power gesture recognition wake-up process in accordance with embodiments of the present invention.

At step 410, the system is powered in a low power state with the wake-up controller coupled to the always on power partition remaining active.

At step 415, the system executes a periodic system wake event in which the wake-up controller coupled to the always on partition activates the gesture recognition module.

At step 420, the gesture recognition module instructs the wake-up controller to activate the proximity sensor to determine if an object is located within a detectable distance of the gesture sensor.

At step 425, a determination is made as to whether an object is within a detectable distance of the gesture sensor. If an object is within a detectable distance, then the gesture recognition module instructs the controller to power on the light sensor, as detailed in step 430. If an object is not within a detectable distance, then the system remains powered in the low power state with the wake-controller remaining active, as detailed in step 410.

At step 430, an object has been determined to be within a detectable distance of the gesture sensor, and therefore, the gesture recognition module instructs the wake-up controller to power on the light sensor to gather brightness level data.

FIG. 5B presents a flowchart which describes exemplary operations in accordance with the various embodiments herein described. FIG. 5B depicts how embodiments of the present invention are operable to perform low power gesture recognition wake-up operations based on data received by the gesture recognition module in accordance with embodiments of the present invention. The details of operation 430 (see FIG. 5A) are outlined in FIG. 5B.

At step 435, the light sensor is powered on by the wake-up controller via control signals received and gathers brightness level data external to the system.

At step 440, data gathered by the light sensor is sent to the gesture recognition module for further processing.

At step 445, a determination is made as to whether the data gathered by the gesture recognition module suggest that the user is waiting to provide gesture input. If the data suggests that the user is waiting to provide gesture input, then the gesture recognition module instructs the wake-up controller to power on the gesture sensor to detect movements performed by the user, as detailed in step 455. If the data does not suggest that the user is waiting to provide gesture input, then the system is powered in the low power mode with the wake-up controller coupled to the always on partition remaining active, as detailed in step 450.

At step 450, the data does not suggest that the user is waiting to provide gesture input and, therefore, the system is powered in the low power mode with the wake-up controller coupled to the always on partition remaining active.

At step 455, the data suggests that the user is waiting to provide gesture input and, therefore, the gesture recognition module instructs the wake-up controller to power on the gesture sensor to detect movements performed by the user. At step 455, a visible indication may be given to the user that the gesture sensor is active.

At step 460, the gesture sensor is powered on by the wake-controller via control signals received and captures movement data performed within a detectable region of the gesture sensor.

At step 465, a determination is made as to whether the movement data gathered at step 460 corresponds to a system recognized gesture stored in memory. If the movement data gathered is determined to be a system recognized gesture, then the system performs a looks up of the corresponding action associated with the recognized gesture, as detailed in step 470. If the movement data gathered is determined to not be a system recognized gesture, then the system is powered off with the wake-up controller coupled to the always on partition remaining active, as detailed in step 450.

At step 470, the movement data gathered at step 460 has been determined to be a system recognized gesture, and therefore, the system performs a look up of the corresponding action associated with the recognized gesture stored in memory.

At step 475, the system executes the actions associated with the recognized gesture and then is powered in the low power mode with the wake-up controller coupled to the always on partition remaining active, as detailed in step 450.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system.

These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above disclosure. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method of gesture recognition, said method comprising:
detecting a system wake event performed using a first portion of a computer system within a mobile device while a second portion of said computer system is within a low power state;
powering up said second portion of said computer system responsive to said system wake event and using said second portion for detecting performance of a gesture input command provided by a user; and
executing a gesture-activated process responsive to said gesture input command.

2. The method as described in claim 1, wherein said second portion of said computer system comprises: a proximity sensor; a light sensor; and a gesture sensor.

3. The method as described in claim 1, wherein said powering up a second portion further comprises removing said second portion of said computer system from said low power state.

4. The method as described in claim 1, wherein said detecting performance further comprises: detecting proximity of a user's hand relative to said computer system; and responsive to detecting proximity of a user's hand, powering up a gesture sensor to sense said gesture input command.

5. The method as described in claim 1, wherein said detecting performance further comprises: gathering brightness level data relative to said computer system; and responsive to a prescribed brightness level data, powering up a gesture sensor to sense said gesture input command.

6. The method as described in claim 4, wherein said powering up said gesture sensor further comprises prompting said user for said gesture input command using a visual notification.

7. The method as described in claim 1, wherein said system wake event corresponds to a periodic signal paging operation performed by said mobile device.

8. A system for gesture recognition, said system comprising:
a gesture recognition module operable to detect performance of a gesture input command, wherein said gesture recognition module is operable to execute a gesture-activated process responsive to said gesture input command;
a gesture sensor operable to capture said gesture input command provided by a user; and
a controller operable to detect a system wake event performed within a computer system of a mobile device, wherein said controller is operable to power up said gesture recognition module responsive to said system wake event and power up said gesture sensor responsive to said system wake event and a detection of a user's hand in proximity to said gesture sensor.

9. The system as described in claim 8, wherein said controller is further operable to power up a proximity sensor responsive to said system wake event to detect said proximity of said hand relative to said computer system for said gesture recognition module.

10. The method as described in claim 8, wherein said controller is further operable to power up a light sensor responsive to said system wake event to gather brightness level data relative to said computer system for said gesture recognition module.

11. The method as described in claim 9, wherein said gesture recognition module is further operable to prompt said user for said gesture input command using visual notification responsive to said gesture sensor being powered up.

12. The method as described in claim 8, wherein said gesture recognition module is further operable to recognize said gesture-activated process responsive to said gesture input command.

13. The method as described in claim 8, wherein said system wake event corresponds to a periodic signal paging operation performed by said mobile device.

14. A method of gesture recognition, said method comprising:
detecting a system wake event performed using a first portion of a computer system within a mobile device while a gesture sensor is in a reduced power state;
powering up a gesture sensor responsive to said system wake event and detecting performance of a gesture input command provided by a user; and
executing a gesture-activated process responsive to said gesture input command.

15. The method as described in claim 14, wherein said powering up a gesture sensor further comprises: powering up a proximity sensor to detect proximity of a hand relative to said computer system; and powering up said gesture sensor responsive to a detection that said hand was in proximity to said computer system.

16. The method as described in claim 14, wherein said powering up a gesture sensor further comprises: powering up a light sensor to gather brightness level data relative to said computer system; and powering up said gesture sensor responsive to detection of a prescribed brightness level data.

17. The method as described in claim 14, wherein said detecting performance further comprises prompting said user for said gesture input command using a visual notification.

18. The method as described in claim 15, wherein said detecting performance further comprises prompting said user for said gesture input command using a visual notification.

19. The method as described in claim 14, wherein said executing further comprises recognizing said gesture-activated process to be associated with said gesture input command.

20. The method as described in claim 14, wherein said system wake event corresponds with a periodic signal paging operation performed by said mobile device.
